(19) United States
(12) Patent Application Publication
(10) Pub. No.: US 2026/0218499 A1
(43) Pub. Date: Jul. 30, 2026

(54) PULLING DEVICE FOR PULLING FAUCET AND THE PULLING FAUCET

(71) Applicant: Xiamen Lota International Co., Ltd., Xiamen (CN)

(72) Inventors: Yongqiang He, Xiamen (CN); Hongxing Hong, Xiamen (CN); Xianqing Ye, Xiamen (CN); Kang Zhao, Xiamen (CN); Chuanbao ZHU, Xiamen (CN)

(21) Appl. No.: 19/223,556

(22) Filed: May 30, 2025

(30) Foreign Application Priority Data
Jan. 24, 2025 (CN) 202510117445.6

(51) Int. Cl. E03C 1/04

(52) U.S. Cl. CPC E03C 1/0404; E03C 2001/0415

(57) ABSTRACT

A pulling device for a pulling faucet, the pulling device is disposed in a faucet seat body of the pulling faucet, the pulling device includes a fixed tube and a slide tube, the slide tube slides up and down in the fixed tube, an inflow space is formed between the slide tube and the fixed tube, an upper end of the slide tube is connected to a pulling tube of the pulling faucet, a lower end of the slide tube is in communication with an outflow end of a valve core of the pulling faucet, the inflow space is in communication with an external water source, and water pressure in the inflow space is configured to applied to the slide tube to push the slide tube to slide downward to drive the pulling tube to move downward.

### RELATED APPLICATIONS

This application claims priority to Chinese patent application number 202510117445.6, filed on January 24, 2025. Chinese patent application number 202510117445.6 is incorporated herein by reference.

### FIELD OF THE DISCLOSURE

The present disclosure relates to a pulling device for a pulling faucet and the pulling faucet.

### BACKGROUND OF THE DISCLOSURE

Pulling kitchen faucets are common kitchen equipment. Structures of the pulling kitchen faucets mainly comprise a main body, an outflow tube, a pulling tube, a pulling head, a weight, a connecting hose, etc. The main body is usually installed on a kitchen countertop, and a built-in valve core is used to control water flow and water temperature. The outflow tube is connected to the pulling tube through the connecting hose. A first end of the pulling tube is connected to the pulling head, and a second end of the pulling tube is fixed to the connecting hose through the weight. During use, the user can pull the pulling head out of the outflow tube for multi-angle and multi-functional cleaning needs, such as cleaning a sink or flushing larger items.

The weight is a key component of the pulling faucet and is usually installed on a lower portion of the pulling tube to help the pulling head to be reset by its own weight. When the users release the pulling head, the pulling tube and the pulling head are pulled back to initial positions by gravity applied to the weight, thus completing a reset operation. In practice, the weight is prone to interfere with the hose or other kitchen equipment (e.g., water tubes, garbage disposals, etc.) that are under the kitchen countertop. Since the hose needs to move freely between the pulling tube and a water source, when the weight collides with the hose or other obstacles, the resulting poor movement of the pulling tube affects pulling experience of the pulling head and increases operational difficulty of the user. The weight is usually fixed to the pulling tube by fasteners or bolts. However, the weight is prone to become loose or displaced due to a shaking of the outflow tube, the pulling tube, and the hose or a collision between the weight and the hose during long-term use. In this case, the pulling head cannot be properly reset by the weight, and the user needs to manually reposition and secure the weight, which not only increases maintenance costs, but also possibly cause inconvenience and discomfort in use. Since the reset is completely dependent on a weight of the weight, it is possible that a reset effect is greatly reduced when an installation environment is complex (e.g., an under-countertop space is tight or a hose arrangement is messy). In addition, a resulting incomplete reset caused by a position deviation of the weight will cause the pulling head to have difficulty in resetting to the initial position and cause problems for the user.

### BRIEF SUMMARY OF THE DISCLOSURE

The objective of the present disclosure is to provide a pulling faucet without a weight to solve the deficiencies in the existing techniques.

In order to solve the aforementioned technical problems, the present disclosure provides a pulling device for a pulling faucet, the pulling device is disposed in a faucet seat body of the pulling faucet, the pulling device comprises a fixed tube and a slide tube, the slide tube slides up and down in the fixed tube, an inflow space is formed between the slide tube and the fixed tube, an upper end of the slide tube is connected to a pulling tube of the pulling faucet, a lower end of the slide tube is in communication with an outflow end of a valve core of the pulling faucet, the inflow space is in communication with an external water source, and water pressure in the inflow space is configured to applied to the slide tube to push the slide tube to slide downward to drive the pulling tube to move downward.

In a preferred embodiment, a pressure-bearing portion is disposed on the slide tube, and the pressure-bearing portion comprises a first pressure-bearing surface in communication with the inflow space and a second pressure-bearing surface in communication with the outflow end of the valve core.

In a preferred embodiment, the pressure-bearing portion is located in the fixed tube, an upper side of the pressure-bearing portion forms the inflow space, and a lower side of the pressure-bearing portion is in communication with the outflow end of the valve core.

In a preferred embodiment, an outflow tube connects the outflow end of the valve core and the fixed tube.

In a preferred embodiment, the pulling device further comprises an inflow seat, the inflow seat is fixedly disposed on the faucet seat body, the fixed tube is fixedly disposed on the inflow seat, a valve seat is disposed on the inflow seat, the inflow seat comprises an internal flow passage connected to the fixed tube and the valve seat, and the valve seat is in communication with the external water source so as to be in communication with the internal flow passage.

In a preferred embodiment, a side of the valve seat facing the fixed tube comprises a mating recess, the mating recess is configured to adapt to an outer side wall of the fixed tube, and the valve seat and the inflow seat are connected by a plug-in structure to enable the valve seat to be connected to the internal flow passage.

In a preferred embodiment, the plug-in structure comprises an inflow recess disposed in the valve seat and an inflow projection disposed on the inflow seat, and the inflow projection is configured to be inserted into the inflow recess.

In a preferred embodiment, the faucet seat body comprises a vertical chamber and a transverse chamber, the transverse chamber is connected to the vertical chamber, the valve seat is configured to be assembled into the transverse chamber, the mating recess of the valve seat is disposed in the vertical chamber, the inflow seat is configured to be inserted through an opening of an upper end of the vertical chamber so as to be inserted into the valve seat, and the mating recess adapts to be positioned at the fixed tube.

In a preferred embodiment, the valve seat is connected to the external water source through an inflow tube, the valve seat comprises a first water dividing passage and a second water dividing passage, the first water dividing passage and the second water dividing passage are respectively connected to the inflow tube, the first water dividing passage is connected to the internal flow passage, and the second water dividing passage is connected to the valve core.

The present disclosure further discloses the pulling faucet, and the pulling faucet comprises the pulling device for the pulling faucet.

Compared with the existing techniques, the technical solution has the following advantages.

The pulling device for the pulling faucet is disposed in the faucet seat body of the pulling faucet, and the pulling device comprises the fixed tube and the slide tube. The slide tube slides up and down in the fixed tube, and the inflow space is formed between the slide tube and the fixed tube. The upper end of the slide tube is connected to the pulling tube of the pulling faucet, and the lower end of the slide tube is in communication with the outflow end of the valve core of the pulling faucet. The inflow space is in communication with the external water source, and the water pressure in the inflow space is configured to act on the slide tube to push the slide tube to slide downward to drive the pulling tube to move downward.

The pulling device utilizes the water pressure to push the slide tube to slide downward to drive the pulling tube to reset without a conventional weight by providing the fixed tube and the slide tube within the faucet seat body. This not only simplifies a structure of the pulling tube, but also effectively avoids an interference situation between the conventional weight and an under-countertop hose or other equipment, thus enabling a pulling process to be smoother and improving user experience.

The water pressure is utilized as a driving force to ensure that the slide tube can be quickly reset to an initial position after use. Compared to gravity reset, which relies on the conventional weight, a thrust provided by the water pressure is more stable and is not affected by an installation environment, allowing for reliable reset even when an under-countertop space is tight or a hose arrangement is messy.

An entire structure of the pulling faucet is more compact and aesthetically pleasing by integrating the pulling device into the faucet seat body. In addition, external parts are reduced using a reset method driven by the water pressure, further improving the overall design sense of the product, which is in line with a design concept of modern kitchens in pursuit of simplicity and efficiency.

### BRIEF DESCRIPTION OF THE DRAWINGS

FIG. 1 shows a perspective view of a pulling faucet in an embodiment of the present disclosure;

FIG. 2 shows an exploded view of the pulling faucet in the embodiment of the present disclosure;

FIG. 3 shows a perspective view of a pulling device in the embodiment of the present disclosure;

FIG. 4 shows a sectional view of the pulling device in the embodiment of the present disclosure;

FIG. 5 shows an enlarged view of a part of FIG. 4;

FIG. 6 shows a sectional view of the pulling faucet in the embodiment of the present disclosure when water flows out of an outflow end of a valve core and a pulling tube is not pulled out;

FIG. 7 shows a sectional view of the pulling faucet in the embodiment of the present disclosure when the water flows out of the outflow end of the valve core and the pulling tube is pulled out;

FIG. 8 shows an enlarged view of a part of FIG. 7; and

FIG. 9 shows a perspective view of the valve core in the embodiment of the present disclosure.

### DETAILED DESCRIPTION OF THE EMBODIMENTS

The present disclosure is further described below in conjunction with the accompanying drawings and the specific embodiments.

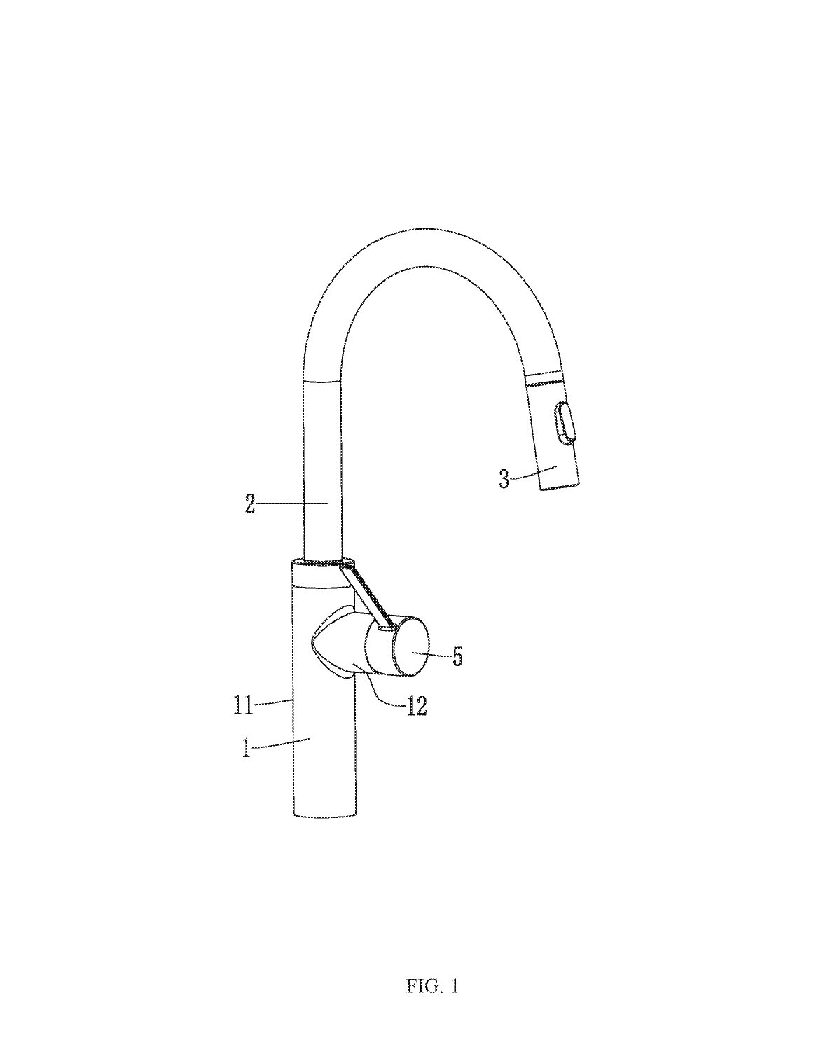

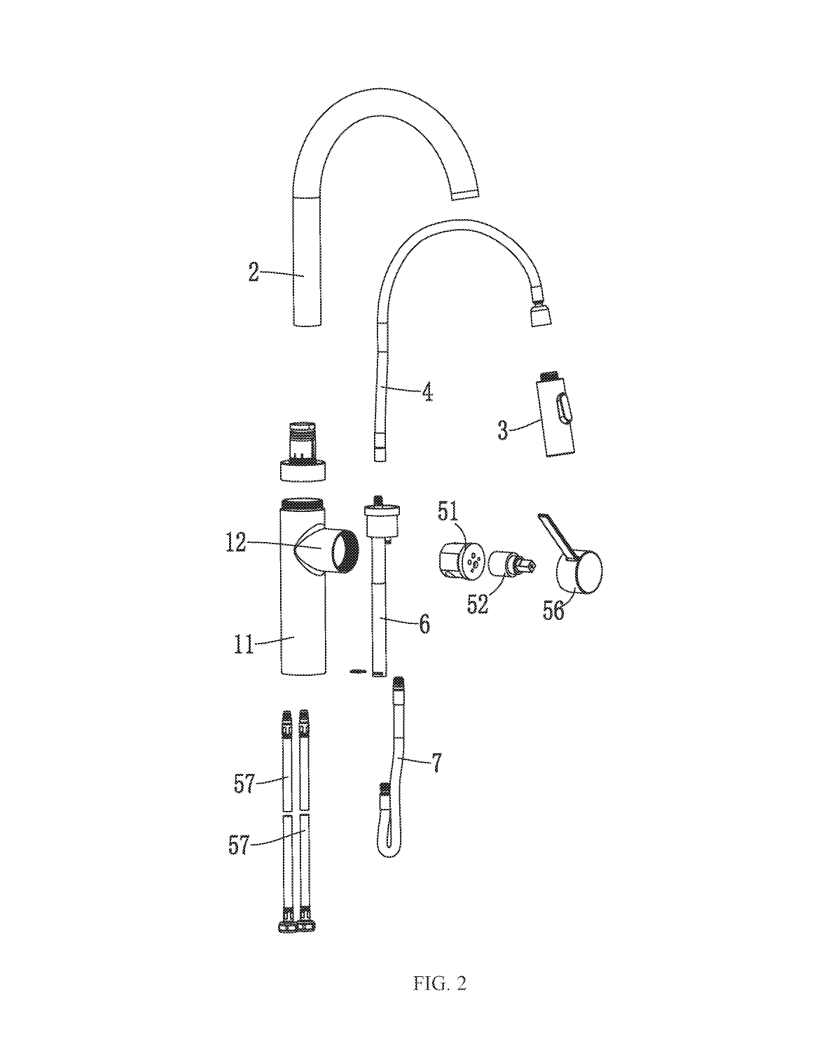

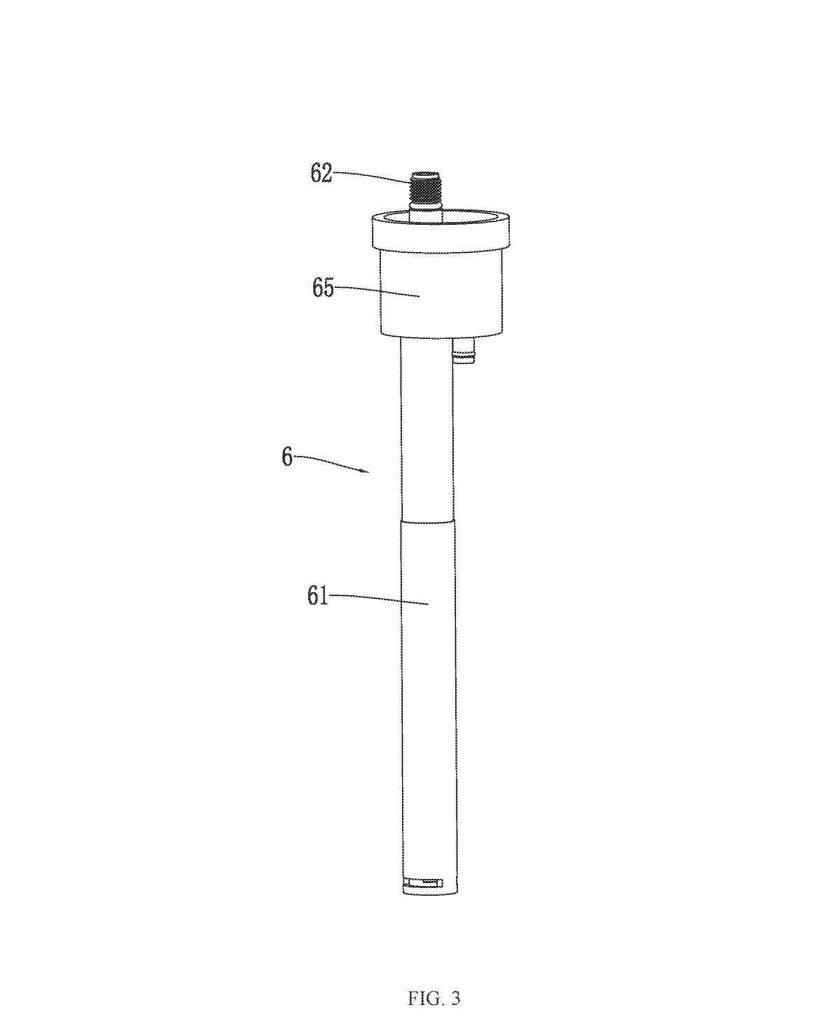

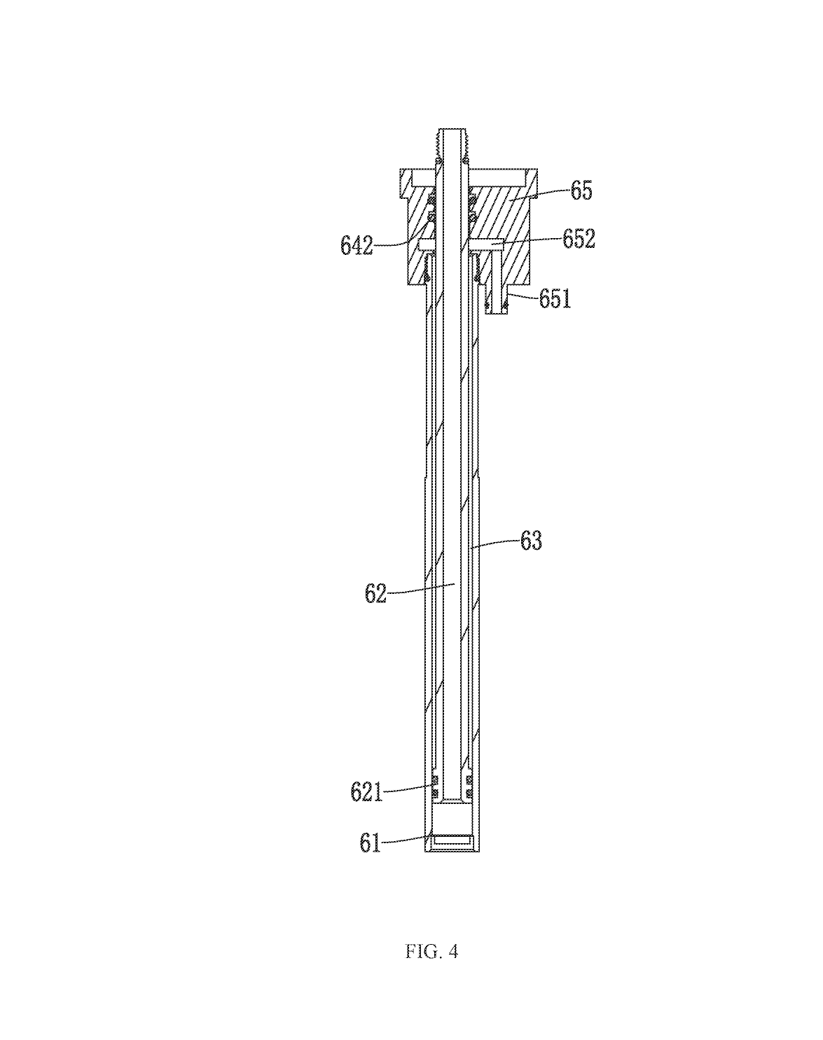

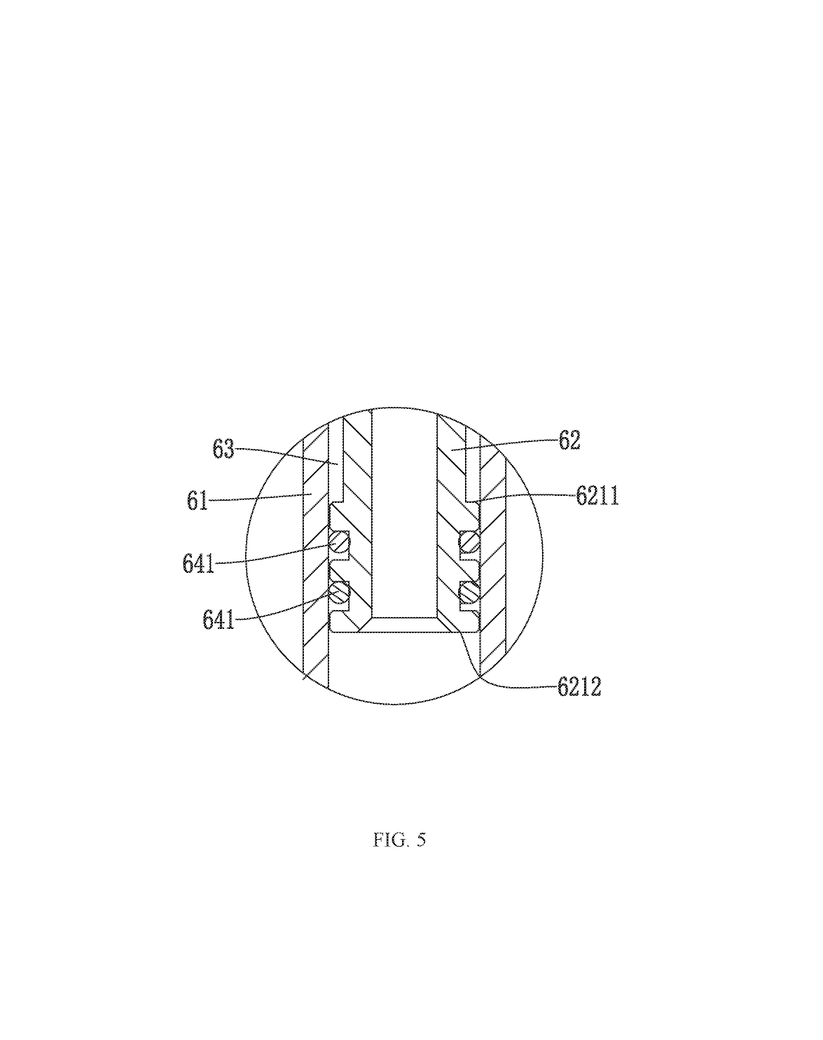

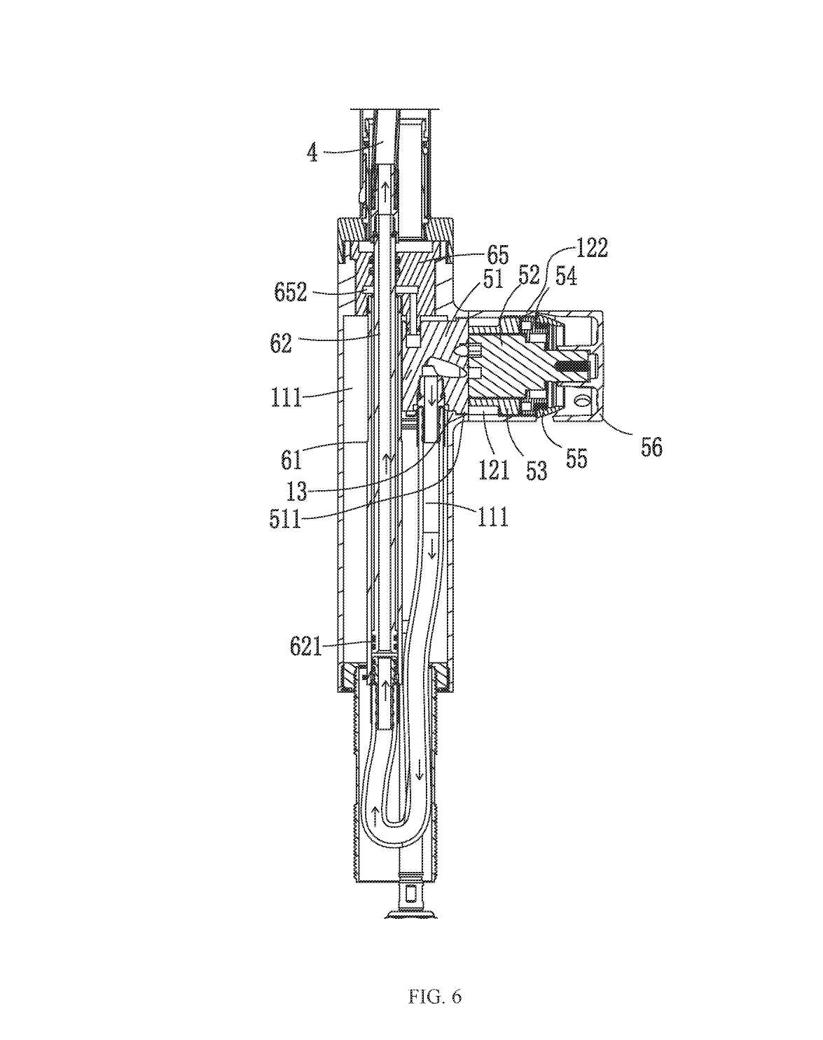

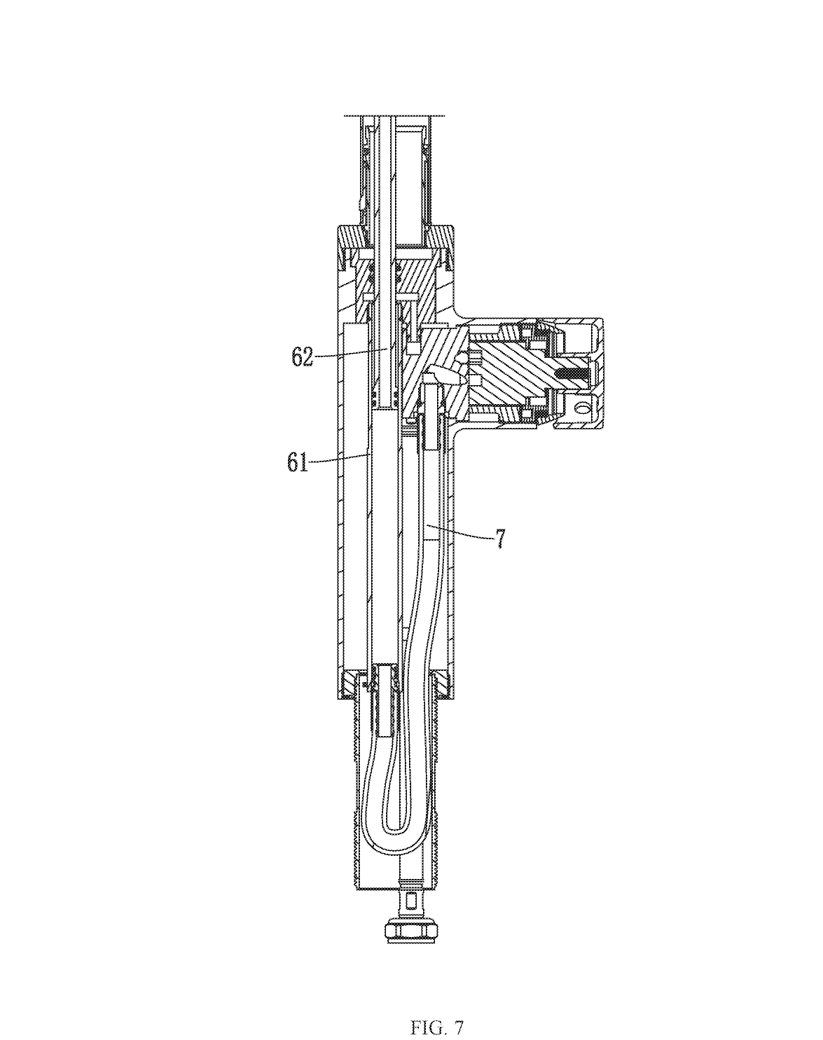

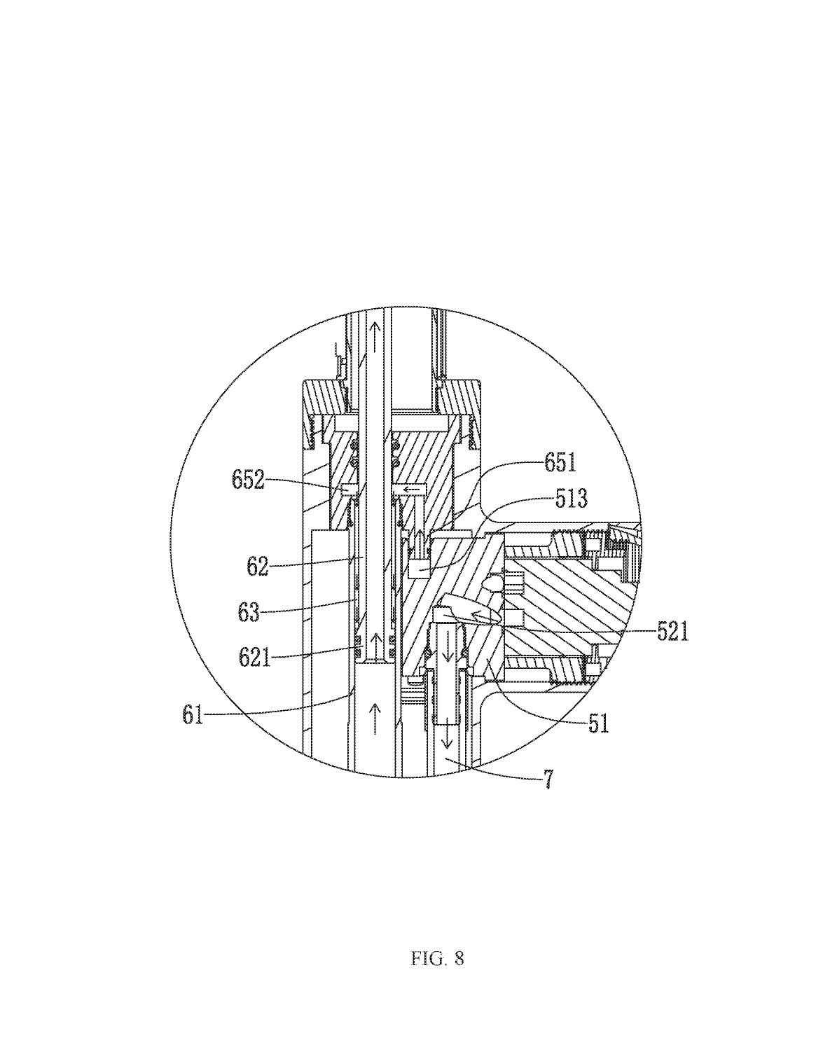

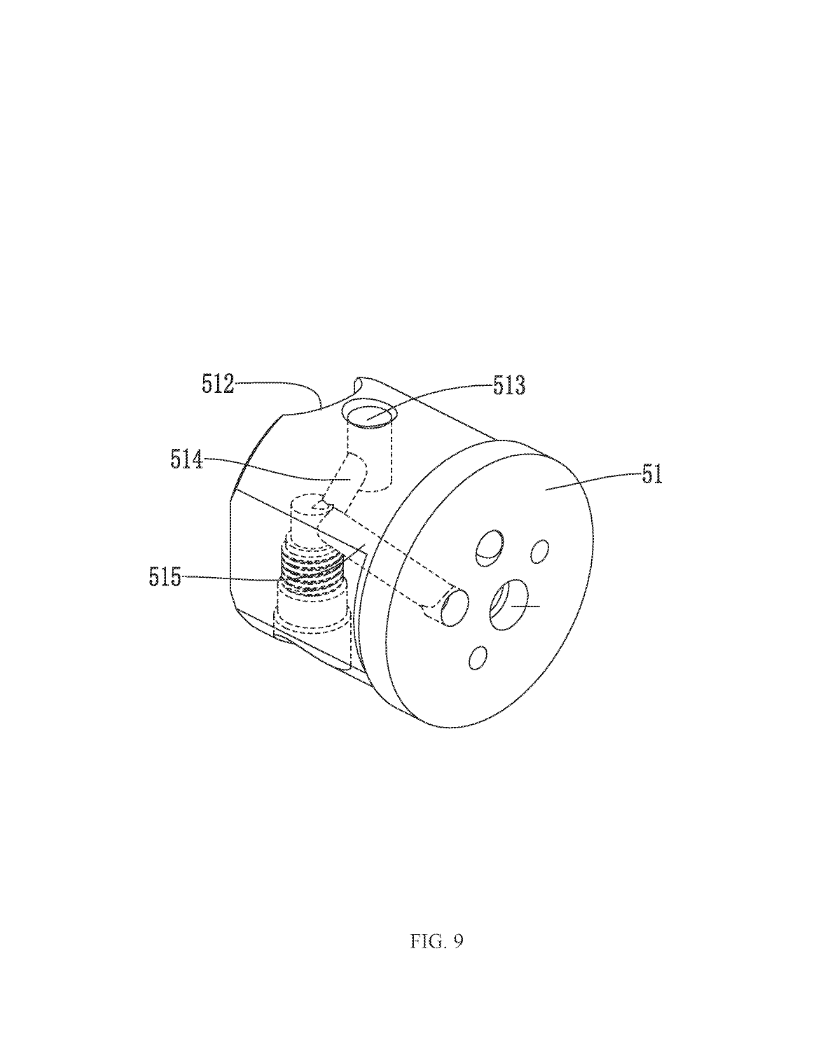

Referring to FIGS. 1-9, a pulling faucet is provided. The pulling faucet comprises a faucet seat body 1, an outflow bend tube 2, an outflow head 3, a pulling tube 4, a valve assembly 5, and a pulling device 6.

The faucet seat body 1 comprises a vertical tube body 11 and a transverse tube body 12, and the vertical tube body 11 and the transverse tube body 12 are connected. An inner side of the vertical tube body 11 comprises a vertical chamber 111, and an inner side of the transverse tube body 12 comprises a transverse chamber 121. A lower end of the vertical tube body 11 can be fixedly connected to a countertop, and a lower end of the outflow bend tube 2 is rotatably connected to an upper end of the vertical tube body 11. The valve assembly 5 is installed on the transverse tube body 12.

The valve assembly 5 comprises a valve seat 51, a valve core 52, a press-fit cover 53, a fixed cover 54, a semi-circular cover 55, and a handle 56. The valve seat 51 can be assembled into the transverse tube body 12 from a side opening 122 of the transverse tube body 12, and a connection position of the vertical tube body 11 and the transverse tube body 12 can contract inward in a radial direction to form a first step 13. An outer periphery of the valve seat 51 forms a second step 511 correspondingly connected to the first step 13. When the second step 511 abuts the first step 13, at least a part of the valve seat 51 extends into the vertical tube body 11. The press-fit cover 53 and an inner side of the transverse tube body 12 are connected to each other by threads to abut and secure the valve seat 51. The valve core 52 is configured to be placed into the transverse chamber 121, and the valve core 52 abuts the valve seat 51 to be fluid communication with the valve seat 51. The valve core 52 can be a temperature control valve capable of controlling a flow amount and a temperature, or the valve core 52 can be a flow valve merely capable of controlling the flow amount, but the disclosure is not limited thereto. The fixed cover 54 and the transverse chamber 121 are connected to each other by threads to abut and secure the valve core 52, and the semi-circular cover 55 is connected to the fixed cover 54 to cover an inlet of the transverse chamber 121.

The pulling device 6 is disposed in the faucet seat body 1. The pulling device 6 comprises a fixed tube 61 and a slide tube 62, and the slide tube 62 slides up and down in the fixed tube 61. An inflow space 63 is formed between the slide tube 62 and the fixed tube 61, and an upper end of the slide tube 62 is connected to the pulling tube 4 of the pulling faucet. A lower end of the pulling tube 4 is connected to the upper end of the slide tube 62, and an upper end of the pulling tube 4 passes through the outflow bend tube 2 and is connected to the outflow head 3.

A lower end of the slide tube 62 is in communication with an outflow end 521 of the valve core 52 of the pulling faucet. The inflow space 63 is in communication with an external water source, and water pressure within the inflow space 63 can be applied to the slide tube 62 to push the slide tube 62 to slide downward so as to drive the pulling tube 4 to move downward. The slide tube 62 is subjected to the water pressure from the inflow space 63 to enable the slide tube 62 to be subjected to a downward thrust, and a user can pull out the outflow head 3 for use. At this time, as the inflow space 63 is in communication with the external water source, the water pressure from the external water source can be continuously conducted into the inflow space 63. The slide tube 62 is always subjected to the water pressure. After the user releases the outflow head 3, the slide tube 62 slides downward to drive the pulling tube 4 to move downward until the outflow head 3 returns to an initial position.

A pressure-bearing portion 621 is disposed on the slide tube 62, and the pressure-bearing portion 621 comprises a first pressure-bearing surface 6211 in communication with the inflow space 63 and a second pressure-bearing surface 6212 in communication with the outflow end 521 of the valve core 52. In this embodiment, the pressure-bearing portion 621 is located in the fixed tube 61. An upper side of the pressure-bearing portion 621 forms the inflow space 63, and a lower side of the pressure-bearing portion 621 is in communication with the outflow end 521 of the valve core 52. In this embodiment, the lower end of the slide tube 62 radially expands outward to form the pressure-bearing portion 621. The first pressure-bearing surface 6211 defines an annular shape and faces the inflow space 63, and the second pressure-bearing surface 6212 defines an annular shape and faces away from the inflow space 63. In a case when both of the inflow space 63 and the outflow end 521 of the valve core 52 have water (i.e., when the water is flowing out of the pulling tube 4), the second pressure-bearing surface 6212 is subjected to an upward thrust, the first pressure-bearing surface 6211 is subjected to a downward thrust, and the downward thrust applied to the first pressure-bearing surface 6211 counteracts the upward thrust applied to the second pressure-bearing surface 6212. Therefore, the user can relatively easily draw out the outflow head 3. In this embodiment, the second pressure-bearing surface 6212 is approximately equal to the first pressure-bearing surface 6211. Therefore, in a case where both of the upper side and the lower side of the pressure-bearing portion 621 are subjected to stresses, the upper end and the lower end of the slide tube 62 are in a balance state with respect to water pressure.

In this embodiment, the pressure-bearing portion 621 is the lower end of the slide tube 62. Therefore, a first sealing ring 641 is hermetically sealed between an outer peripheral wall of the pressure-bearing portion 621 and an inner wall of the fixed tube 61. As the first sealing ring 641 is disposed between the first pressure-bearing surface 6211 and the second pressure-bearing surface 6212, the first sealing ring 641 slides more stably.

An outflow tube 7 is connected between the outflow end 521 of the valve core 52 and the fixed tube 61. The outflow end 521 of the valve core 52 can be controlled by the valve core 52 to discharge the water or to stop discharging the water. When the water is discharged from the outflow end 521 of the valve core 52, the water enters into the fixed tube 61 through the outflow tube 7 and then flows into the slide tube 62 from the lower end of the slide tube 62. The water then flows into the pulling tube 4 from the upper end of the slide tube 62 and eventually flows out of the outflow head 3. During this process, as the slide tube 62 is in the balance state with respect to the water pressure, the user can more easily pull and bring out the outflow head 3. When the water stops flowing out of the outflow end 521 of the valve core 52, the slide tube 62 is merely subjected to the downward thrust as the second pressure-bearing surface 6212 is not subjected to the water pressure, and the water from the external water source can continuously enter into the inflow space 63, forcing the slide tube 62 to move downward to drive the pulling tube 4 to move downward.

The pulling device 6 further comprises an inflow seat 65. The inflow seat 65 is fixedly disposed on the faucet seat body 1, and the fixed tube 61 is fixedly disposed on the inflow seat 65. The valve seat 51 is disposed on the inflow seat 65, and the inflow seat 65 comprises an internal flow passage 652 connecting the fixed tube 61 and valve seat 51. The valve seat 51 is in communication with the external water source to be in communication with the internal flow passage 652. An upper end of the fixed tube 61 is connected to the inflow seat 65 by threads, and the upper end of the fixed tube 61 and the internal flow passage 652 are connected to each other. The upper end of the slide tube 62 upwardly passes through the inflow seat 65 and is slidably connected to the inflow seat 65. A second sealing ring 642 is hermetically sealed between an outer wall of the slide tube 62 and the inflow seat 65, and the slide tube 62 slides more stably through the first sealing ring 641 and the second sealing ring 642.

One side of the valve seat 51 facing the fixed tube 61 comprises a mating recess 512. The mating recess 512 can adapt to an outer side wall of the fixed tube 61, and the valve seat 51 and the inflow seat 65 are connected by a plug-in structure to enable the valve seat 51 to connect to the internal flow passage 652. In this embodiment, the plug-in structure comprises an inflow recess 513 disposed on the valve seat 51 and an inflow projection 651 disposed on the inflow seat 65, and the inflow projection 651 is configured to be inserted into the inflow recess 513.

During installation, the valve seat 51 is configured to be disposed in the transverse chamber 121, and the mating recess 512 of the valve seat 51 is disposed in the vertical chamber 111. The inflow seat 65 is configured to be inserted through an opening of an upper end of the vertical chamber 111 so as to be configured to be inserted into the valve seat 51. The inflow seat 65 is configured to be buckled to the opening of the upper end of the vertical chamber 111, and the mating recess 512 adapts to be positioned at the fixed tube 61. Specifically, the valve assembly 5 is firstly installed on the transverse chamber 121, and the fixed tube 61 and slide tube 62 are connected to the inflow seat 65. The inflow seat 65 is then downwardly installed on the opening of the upper end of the vertical chamber 111. At this time, the fixed tube 61 is disposed in the vertical chamber 111 and adapts to be positioned at the mating recess 512. The outflow tube 7 is then connected to the valve seat 51 and the fixed tube 61.

In this embodiment, the valve seat 51 is connected to the external water source through an inflow tube 57, and the valve seat 51 comprises a first water dividing passage 514 and a second water dividing passage 515. The first water dividing passage 514 and the second water dividing passage 515 are respectively connected to the inflow tube 57. The first water dividing passage 514 is connected to the internal flow passage 652, and the second water dividing passage 515 is connected to the valve core 52. Both of the first water dividing passage 514 and the second water dividing passage 515 are connected to the inflow tube 57. Therefore, when the outflow end 521 of the valve core 52 is opened and the slide tube 62 moves upward, the water in the inflow space 63 can flow to the valve core 52 from the first water dividing passage 514 (the first water dividing passage 514 and the second water dividing passage 515 are connected through the inflow tube 57) without generating a pressure buildup. Further, when the water stops flowing out of the outflow end 521 of the valve core 52, excessive water in the fixed tube 61 can flow out through the outflow head 3.

In this embodiment, the fixed tube 61 is a rigid tube, and the slide tube 62 is a flexible tube or a rigid tube.

The aforementioned description is merely specific preferred implements of the present disclosure, while the design and the concept of the present disclosure are not limited thereto. Non-substantive modifications of the present disclosure fall within the protection scope of the present disclosure provided that they are made based on the concept within the technical scope disclosed by the present disclosure by any person of ordinary skill in the art.

What is claimed is:

1. A pulling device for a pulling faucet, wherein:
the pulling device is disposed in a faucet seat body of the pulling faucet,
the pulling device comprises a fixed tube and a slide tube,
the slide tube slides up and down in the fixed tube,
an inflow space is formed between the slide tube and the fixed tube,
an upper end of the slide tube is connected to a pulling tube of the pulling faucet,
a lower end of the slide tube is in communication with an outflow end of a valve core of the pulling faucet,
the inflow space is in communication with an external water source, and
water pressure in the inflow space is configured to be applied to the slide tube to push the slide tube to slide downward to drive the pulling tube to move downward.

2. The pulling device for the pulling faucet according to claim 1, wherein:
a pressure-bearing portion is disposed on the slide tube, and
the pressure-bearing portion comprises a first pressure-bearing surface in communication with the inflow space and a second pressure-bearing surface in communication with the outflow end of the valve core.

3. The pulling device for the pulling faucet according to claim 2, wherein:
the pressure-bearing portion is located in the fixed tube,
an upper side of the pressure-bearing portion forms the inflow space, and
a lower side of the pressure-bearing portion is in communication with the outflow end of the valve core.

4. The pulling device for the pulling faucet according to claim 1, wherein an outflow tube connects the outflow end of the valve core and the fixed tube.

5. The pulling device for the pulling faucet according to claim 1, wherein:
the pulling device further comprises an inflow seat,
the inflow seat is fixedly disposed on the faucet seat body,
the fixed tube is fixedly disposed on the inflow seat,
a valve seat is disposed on the inflow seat,
the inflow seat comprises an internal flow passage connected to the fixed tube and the valve seat, and
the valve seat is in communication with the external water source so as to be in communication with the internal flow passage.

6. The pulling device for the pulling faucet according to claim 5, wherein:
a side of the valve seat facing the fixed tube comprises a mating recess,
the mating recess is configured to adapt to an outer side wall of the fixed tube, and
the valve seat and the inflow seat are connected by a plug-in structure to enable the valve seat to be connected to the internal flow passage.

7. The pulling device for the pulling faucet according to claim 6, wherein:
the plug-in structure comprises an inflow recess disposed in the valve seat and an inflow projection disposed on the inflow seat, and
the inflow projection is configured to be inserted into the inflow recess.

8. The pulling device for the pulling faucet according to claim 6, wherein:
the faucet seat body comprises a vertical chamber and a transverse chamber,
the transverse chamber is connected to the vertical chamber,
the valve seat is configured to be assembled into the transverse chamber,
the mating recess of the valve seat is disposed in the vertical chamber,
the inflow seat is configured to be inserted through an opening of an upper end of the vertical chamber so as to be inserted into the valve seat, and
the mating recess adapts to be positioned at the fixed tube.

9. The pulling device for the pulling faucet according to claim 5, wherein:
the valve seat is connected to the external water source through an inflow tube,
the valve seat comprises a first water dividing passage and a second water dividing passage,
the first water dividing passage and the second water dividing passage are respectively connected to the inflow tube,
the first water dividing passage is connected to the internal flow passage, and
the second water dividing passage is connected to the valve core.

10. The pulling faucet, wherein the pulling faucet comprises the pulling device for the pulling faucet according to claim 1.
